(19) United States
(12) Patent Application Publication
(10) Pub. No.: US 2004/0081952 A1
(43) Pub. Date: Apr. 29, 2004

(54) Online learning system

(76) Inventors: Barclay Fred Burns, Portland, OR (US); Justin Trevor Garrity, Forest Grove, OR (US); Jonthan Edward Graham, Portland, OR (US); Darbi Lynn Seely, Lake Oswego, OR (US); Paul William Ownby, Portland, OR (US)

Correspondence Address: Julie L. Reed, MARGER JOHNSON & McCOLLOM, P.C., 1030 S.W. Morrison Street, Portland, OR, 97205, US

(21) Appl. No.: 10/687,100

(22) Filed: Oct. 15, 2003

Related U.S. Application Data
(60) Provisional application No. 60/419,248, filed on Oct. 16, 2002.

(51) Int. Cl. G09B 3/00

(52) U.S. Cl. 434/350

(57) ABSTRACT

A method of simulating application software includes presenting a generic application user interface for a particular type of application to a user across a network. The simulation receives user inputs during an interaction with the user interface. A management system evaluates performance of the user with regard to the type of application based upon the user inputs. The user inputs may be stored for later evaluation.

This application is a continuation of, and claims priority to, U.S. Provisional Patent Application No. 60/419,248, filed Oct. 16, 2002, incorporated by reference herein.

### BACKGROUND

The use of computers and other technology in the classroom has become a necessary part of any curriculum. Typically, the student uses the computer to interact with some sort of evaluation that is presented to the teacher at the end of the interaction. The evaluation is generally about how the student performed with respect to the content. For example, if the student is being tested on reading comprehension, the evaluation may be a list of right and wrong answers to questions about a story. If the interaction is a math game, the game may present an evaluation on the number of right and wrong answers, or how well the student did in a particular type of math problem, etc.

Technology instruction, such as computer classes or labs, is generally directed to teaching the students to use various computer applications. Students are guided through a spreadsheet, word processing or presentation task, for example, but not in support of any particular core subject, such as math or reading or writing. In addition, the interactions are generally with the teacher observing the student's actual interaction with the computer, with no evaluation given as may happen with the evaluations mentioned above.

### BRIEF DESCRIPTION OF THE DRAWINGS

Embodiments of the invention may be best understood by reading the disclosure with reference to the drawings, wherein:

FIG. 1 shows an embodiment of an instructional system.

FIG. 2 shows a flowchart of an embodiment of a method to provide an integrated learning system.

FIGS. 3a-b show embodiments of a generic user interface for a software application simulation.

FIG. 4 shows a flowchart of an embodiment of a method to present a user interface.

FIG. 5 shows a flowchart of an embodiment of a method to track performance with regard to simulated application software.

### DETAILED DESCRIPTION OF THE EMBODIMENTS

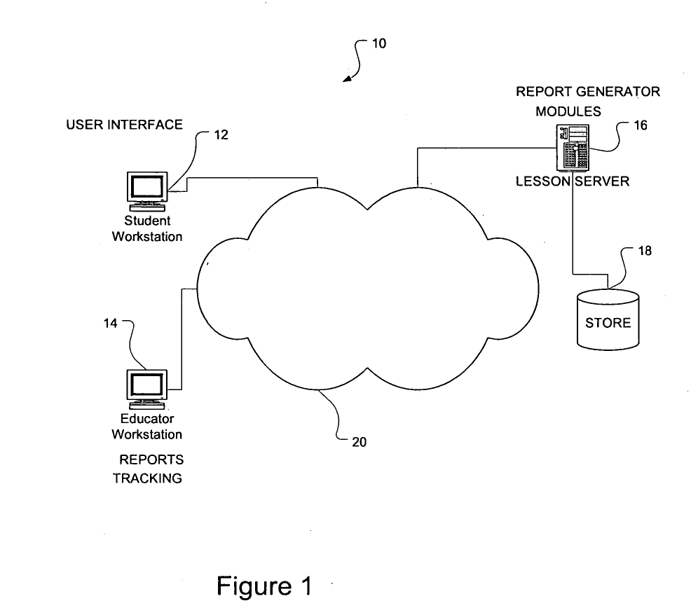

FIG. 1 shows a network in which an instruction system is implemented. The instructional system 10 has at least one student workstation 12 through which student's interact with the system. As will be discussed in more detail later, a user interface that simulates one of several different types of application is presented to the student on the student workstation 12.

In addition, there is an educator workstation 14. The educator workstation 14 may be of the same or different kind of workstation as the student workstation. The educator workstation may also be the same workstation as that used by the student. Typically, when an educator accesses the instructional system 10, the interfaces and function presented will vary greatly from that presented to the students.

A server 16 or other repository of instructional material provides lessons and other information to the students. This repository will be referred to here as a server, but may be any other type of repository with retrieval intelligence. Additionally, the lesson server 16 may also generate reports on student performance to be presented at the educator workstation. The system may also have a store 18, which may also be part of the lesson server. Alternatively, each of these functions of lesson repository, report generation and storage may be embodied in separate devices, or combinations of the functions on different devices.

The instructional system 10, however configured, operates to provide students with instructional material related to software applications. For example, software applications include spreadsheets, word processors, databases, and presentation software. In one embodiment the instructional system provides instruction on application software and the use of technology in support of the core curriculum subjects.

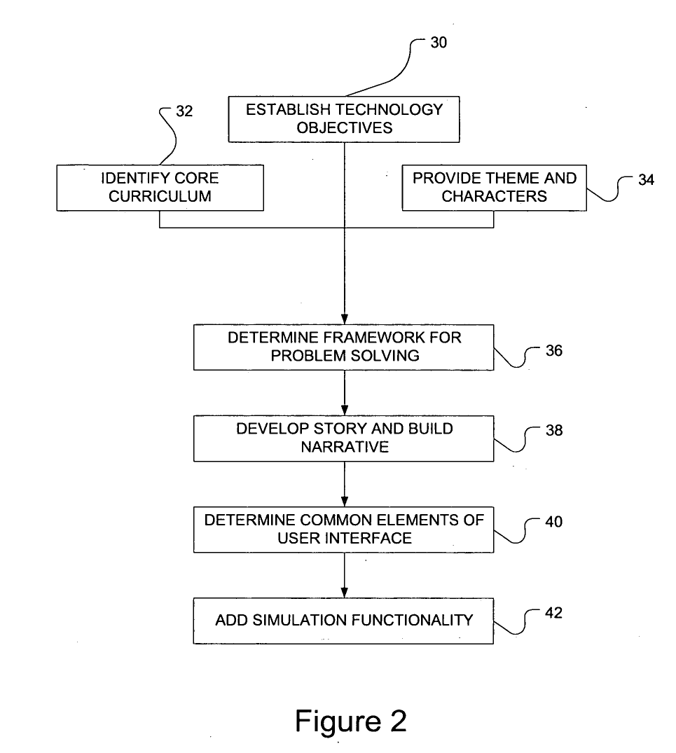

The system utilizes objectives derived from national and state technology standards. An embodiment of a method to provide an integrated technology learning system is shown in FIG. 2. The International Society for Technology in Education (ISTE) has set out standards in the National Educational Technology Standards (NETS). These standards are converted into a series of technology objectives that the system enables the students to reach at 30. The objectives will typically outline what the student must understand and do to demonstrate that he or she has met a particular standard.

The technology objectives may be further broken down into topic- or tool-related groups. These groups will be referred to here as units. Each unit may consist of lessons that teach the concepts outlined in the appropriate technology objective group. The objectives for each unit may then be divided into lesson groups. This division may be based upon how well the objectives fit together and the logical order in which the student should learn them to be the most successful with that technology objective group, or area.

In order to integrate the technology learning with the student's curriculum, tie-ins to the core curriculum are identified and provided at 32. The core curriculum may be math, language arts, geography or other subject matters about which the student's learning is organized. One method to create this curricular tie-in is to establish a grade range based upon standard requirements for a particular lesson within a unit. The grade range determines the length of the lesson, as well as helping to identify which national or state core curriculum standards that would fit well with particular technology tasks of a lesson at 34.

Once the objectives, tie-ins and grade range are determined, a framework for problem solving within the lesson is determined at 36. For example, a second grade lesson on spreadsheets may use a certain theme with a theme-appropriate character, as will be used in further examples. The characters may relate to a particular career or hobby that might use the technology tasks or tools outlined in the lesson. A general storyline is then developed, with a narrative structure at 38. The narrative structure may also act as a helper and motivational guide for the student. Each lesson is structured around a particular task or problem that the character is facing. By the end of the lesson, the student will have solved the problem or created a product by using realistic technology skills in the context of a real-life situation.

The lessons are designed to be effective and applicable to any title in a particular group of software, such as database, spreadsheet, word processing, or presentation software. In order to do this a user interface must be provided at 40 that has a ‘generic’ interface, with elements common to most of the popular software packages.

The ‘generic’ user interface is one that has enough common elements that the student could move to a specific software application and be able to use it by what the student learned while interacting with the generic interface. For example, more popular spreadsheet applications such as Microsoft® Excel® and AppleWorks® spreadsheet, as well as the spreadsheet application in Microsoft® Works® typically present a user interface with rows and columns. The rows are typically labeled by numbers and the columns by letters. The simulated interface would also layout the spreadsheet in this fashion, to be generic to the more popular packages.

In addition, the lessons will typically be delivered across a network through a browser window, so are platform independent, removing any particular platform dependencies in the interface. The simulation generic interface is also generic across an application on different platforms. For example, Excel® looks different when viewed on a PC versus a Macintosh®. The simulated interface is generic to both operating systems and specific applications.

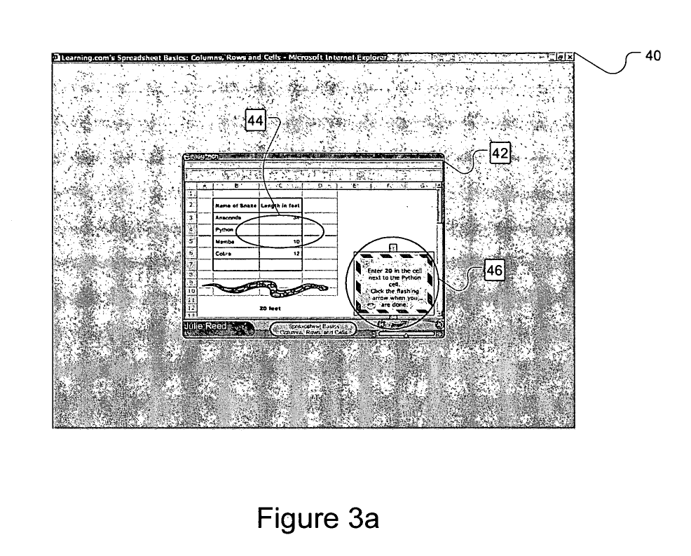

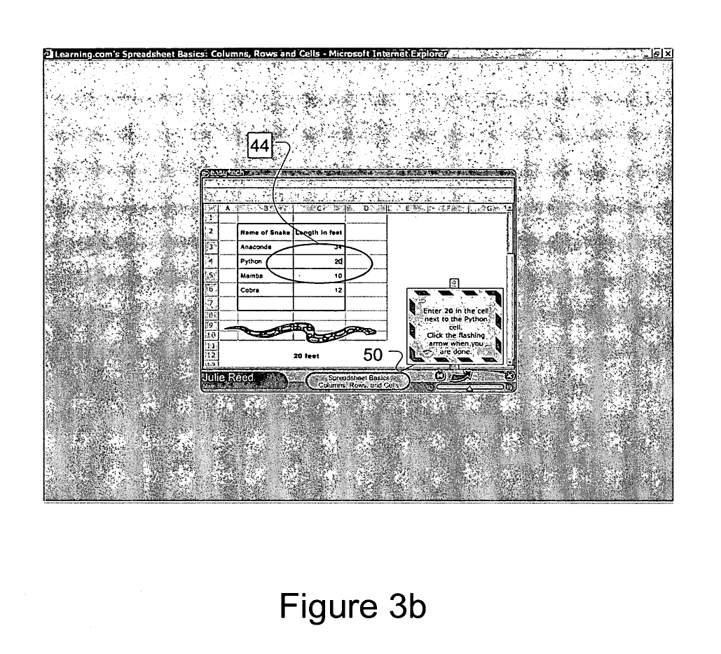

Examples of a generic spreadsheet interface within a zookeeper narrative are shown in FIGS. 3a and 3b. In FIG. 3a, a browser window 40 has within it the generic user interface window 42. A generic-depiction of a spreadsheet having rows and columns is shown. The region for user input 44 shows where the student is to enter the appropriate numbers to complete the task given in the narrative. In addition, a helper or prompt window 46 assists the student with the substantive elements of the task, in this case that the python is 20 feet long. In order to advance the narrative to the next part of the task, the student must demonstrate the skill of number entry in a spreadsheet.

As will be discussed in more detail further, the interface is a simulation of the application, not the interface of an actual application across a network. The student's experience is tailored and the simulation response is based upon the inputs, in addition to the actual software response. The simulation of the interface and the processes for capturing the inputs may be referred to as 'simulation functionality and is added to the system at 42.

In FIG. 3b, the student has entered their input of the number 20 into the input region 44. In the context of a spreadsheet, this input would be captured when the spreadsheet is saved. However, as mentioned above, this is a simulation of a spreadsheet. The capture of the actual number is not necessarily important. What is important is the capture of the student's response as well as the environment in which that response is given. The environment of the response may be the location or scene in the lesson in which the answer was recorded. As will be discussed later, the capture of this information allows the educator and student to evaluate how the student performed with respect to the particular task in the application or how the student performed with respect to a particular subject matter.

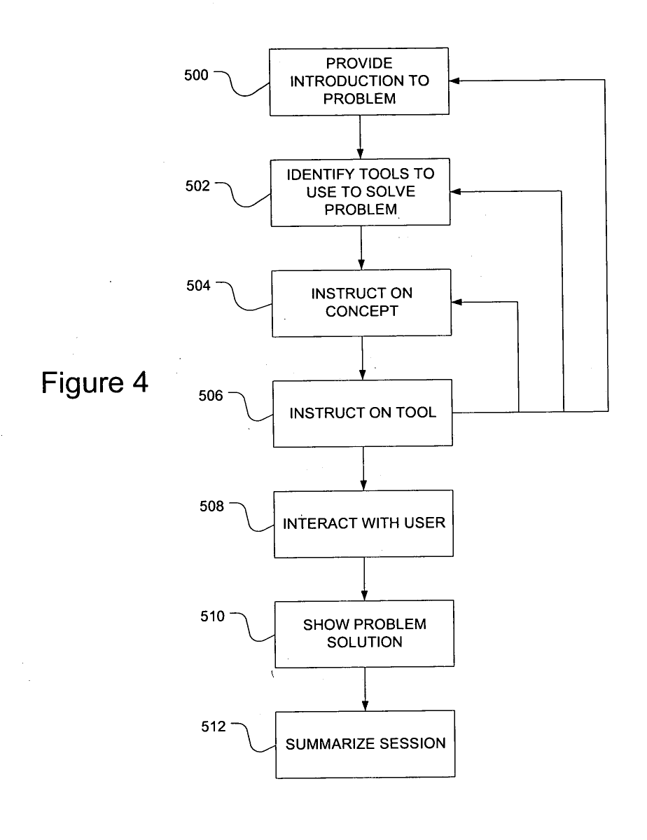

FIG. 4 shows a flowchart of an embodiment for presenting a user interface for simulated application software. At 500, the interface provides an introduction to the problem. As mentioned earlier, the problem is generally set inside a narrative with appropriate characters to engage the student and provide a ‘real-world’ feel to the interaction. At 502, the interface identifies the tools that will be used to solve the problem. Returning to the spreadsheet example used above, the tool identified would be a spreadsheet. In addition, other types of software applications may be identified, or a hardware component, such as a mouse, keyboard or printer.

At 504, the interface instructs the student on the concept, such as using a spreadsheet to organize, tabulate and/or graph information for a particular purpose. At 506, the interface then instructs the student about the particular tool such as a software application to be used, such as the particular characteristics of a spreadsheet, where the input fields are laid out in rows and columns and that the columns are lettered and the rows numbered.

The actual interaction with the user occurs at 508. At this point in the simulation, the student enters the requested information in what may be referred to as a ‘do sequence.’ The interface then provides feedback to the student as part of the interaction. Once the interaction is completed, the problem solution is shown to the student, whether the solution was from the student solving the problem, or the solution being demonstrated, as will be discussed further. At 512, the task session is summarized, where the task session is the sequence of events that occurred with regard to a particular task.

In general, the process of FIG. 4 presents a generic user interface for a particular application to be used to solve a problem, receiving user inputs with regard to the problem and then providing feedback to the user.

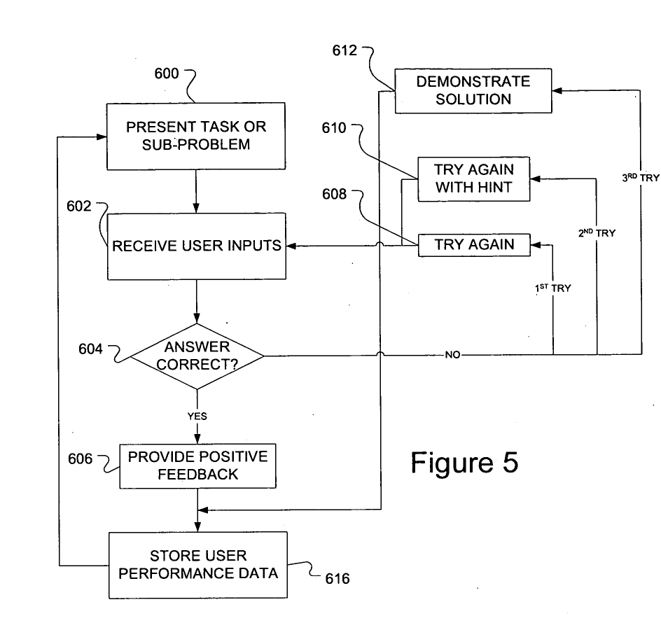

As discussed above, one advantage of the simulated interface is the ability to provide feedback and to tailor the student experience based upon the student's inputs, rather than just providing the standard software application response. A more detailed embodiment of the interaction between the user and the user interface with regard to the do sequence is shown in FIG. 5.

At 600, the task to be accomplished by the student or the sub-problem to be solved is presented. The user provides his or her inputs in 602. At 604, the simulation's response depends upon the user inputs being correct or incorrect. If the input is correct, the student receives positive feedback at 606. If the student input is incorrect, and it is the student's first try, the student is prompted to try again at 608. If the input is the student's second try, the student is prompted to try again and a hint is provided at 610. On the third incorrect response, the solution is demonstrated at 612. After the solution is demonstrated, the user performance is stored at 616, which also occurs after a correct answer and the positive feedback. The example above, of three possible tries, is merely intended as an example of an iterative feedback that adapts its response based upon the number of tries the student has attempted.

The storing of the user performance data, such as the responses, their correctness, and the environment in which the responses were given relate back to the management functions of the system of FIG. 1. As mentioned above, the lesson or other server 16 may use these responses stored in store 18. The report generator can then provide an educator with varying levels of tracking and reporting at the educator workstation 14.

Reports may be generated based upon a class, a lesson, a unit or an individual student, as examples. The reports are based upon information stored during the interaction of the students during the different lessons. In one embodiment, a new record is created in a database in the store every time a lesson is launched. The record contains the date and time the lesson was started, the student launching the lesson, and the class from which the student took the lesson. The results of the interaction as well as the environment in which answers were provided are also stored, as is the number of tries needed to complete each task. The record may then be updated with the student's score and information containing more details.

This information can then be used to generate reports such as a class report, a lesson report, a student report and a school usage report. A class report gives a view of a class's progress through the lessons of a unit. A lesson report provides information about an individual lesson. The student report provides information about an individual's performance. A school usage report lists all the classes in the school and the teachers who teach them, as well as the number of lessons assigned in a class, the number of lessons started by a class and the number of times a lesson has been completed.

Other information may also be stored, such as IP addresses of individual machines using the lessons, browser versions, and multimedia player versions of the multimedia players used to present the lessons across the network. This information may be helpful in determining system problems and to assist with technical support. The management aspects of the system also allow the teacher to add lessons, classes or to change or supplement existing lessons. These changes may be based upon the reports generated above.

In this manner, an on-line learning system is provided that teaches mastery of technological skills in a real-world setting. By providing a simulation of software applications, student performance of their abilities with regard to the application software can be captured and evaluated. The simulation presents a user interface that allows the students to apply what they learned to many different versions of a particular application. The simulations and settings are tied to core curriculum subject areas, supporting student progress in those areas as well.

The learning system, user interfaces and simulation functions may be implemented as software instructions operating on a machine. The software instructions, or code, cause the machine to perform the methods, of the invention when executed, and may be stored on an article of machine-readable media, such as a diskette, compact disc, or hard disc.

Thus, although there has been described to this point a particular embodiment for a method and apparatus for an on-line integrated learning system it is not intended that such specific references be considered as limitations upon the scope of this invention except in-so-far as set forth in the following claims.

What is claimed is:

1. A method of simulating application software, comprising:
presenting a generic application user interface for a particular type of application to a user across a network;
receiving user inputs during an interaction with the user interface; and
evaluating performance of the user with regard to the type of application based upon the user inputs.

2. The method of claim 1, the method comprising providing feedback to the user on the performance of the user.

3. The method of claim 2, providing feedback further comprising:
informing the user of a wrong input; and
presenting the user with an opportunity to try again.

4. The method of claim 1, providing feedback further comprising
informing the user of a wrong input;
providing a hint to the user; and
presenting the user with an opportunity to try again.

5. The method of claim 1, providing feedback further comprising:
informing the user of a wrong input; and
demonstrating to the user the correct input.

6. The method of claim 1, the method comprising collecting all of the user inputs and evaluations of the user inputs and generating an evaluation report of the performance of the user.

7. The method of claim 1, presenting a generic user interface for a particular application type further comprising presenting a generic user interface for an application selected from the group comprising: a spreadsheet, a word processor, and a presentation application.

8. A method of providing a user interface, comprising:
providing an introduction to a problem for a user;
identifying tools to solve the problem;
instructing the user on concepts and tools to be used in a solution;
interacting with the user;
displaying the solution; and
providing the user with a summary of the problem and solution.

9. The method of claim 8, interacting with the user further comprising receiving a user input and storing the user input for further evaluation.

10. The method of claim 8, interacting with the user further comprising receiving and evaluating a user input.

11. The method of claim 8, interacting with the user further comprising providing feedback.

12. The method of claim 11, providing feedback further comprising indicating that the user made a correct input.

13. The method of claim 11, providing feedback further comprising indicating that the user may an incorrect input and displaying a region on the window in which the user may make another input.

14. A method of providing an integrated technology learning system, comprising:
establishing technology objectives for an instructional unit;
identifying core curriculum components related to the technology objectives;
providing a theme and characters for the unit;
determining a framework for problem solving;
determining common elements of a user interface; and
adding simulation functionality.

15. The method of claim 14, adding simulation functionality further comprising:
recording user inputs in response to prompts;
recording a environment from which the user input is recorded; and
storing the user inputs and the environment.

16. An instructional management system, comprising:
at least one instructional unit having at least one task for which a student is required to provide an input;
a user interface simulating a software application having a region to allow the student to provide the input;
a memory in which to record the student input;
a report generator to allow an instructor to access results of the inputs and to provide an evaluation of student performance with regard to the software application.

17. An article of machine-readable media containing instructions that, when executed, cause the machine to:
present a generic application user interface for a particular type of application to a user across a network;
receive user inputs during an interaction with the user interface; and
evaluate performance of the user with regard to the type of application based upon the user inputs.

18. The article of claim 17, the article containing instructions that, when executed, cause the machine to provide feedback to the user on the performance of the user.

19. An article of machine-readable media containing instructions that, when executed, cause the machine to:
provide an introduction to a problem for a user;
identify tools to solve the problem;
instruct the user on concepts and tools to be used in a solution;
interact with the user;
display the solution; and
provide the user with a summary of the problem and solution.
